(19) United States
(12) Patent Application Publication
(10) Pub. No.: US 2015/0153698 A1
(43) Pub. Date: Jun. 4, 2015

(54) IMAGE FORMING APPARATUS

(71) Applicant: CANON KABUSHIKI KAISHA, Tokyo (JP)

(72) Inventors: Masafumi Monde, Yokohama-shi (JP); Masaru Tanaka, Numazu-shi (JP); Yuya Yanagi, Mishima-shi (JP)

(21) Appl. No.: 14/548,496

(22) Filed: Nov. 20, 2014

(30) Foreign Application Priority Data
Dec. 2, 2013 (JP) 2013-249187

(51) Int. Cl. G03G 15/00

(52) U.S. Cl. CPC G03G 15/6529

(57) ABSTRACT

An image forming apparatus includes: an image forming portion for forming an image on sheets; a stacking portion for stacking sheets on which the images are formed by the image forming portion; and a controller for integrating the number of sheets on which the images are formed. The controller integrates the number of sheets, from an initial value in one print job, on which the images are formed by the image forming portion and which are then stacked on the stacking portion, and stops an operation of the image forming portion when an integrated value reaches a predetermined number.

### FIELD OF THE INVENTION AND RELATED ART

The present invention relates to an image forming apparatus such as a laser printer, a copying machine or a facsimile machine, and particularly relates to a technique for preventing drop of a recording material stacked on a sheet discharge portion and for preventing jam of the recording material.

The image forming apparatus includes a sheet feeding portion in which the recording material (sheet) such as recording paper or an OHP sheet is accommodated, an image forming portion for forming and fixing an image on the sheet (recording material) fed from the sheet feeding portion, and the sheet discharge portion where the sheet after the image formation is discharged and stacked. At the sheet discharge portion, a maximum number of sheets stacked (maximum stacked sheet number) is determined depending on a structure of the sheet discharge portion, and when the number of sheets exceeds the maximum stacked sheet number, a jam of the sheet or a drop of the sheet from the sheet discharge portion is caused to occur in some cases. Therefore, there was in general a case where the image forming apparatus is provided with a full stacked state detecting means for the sheet discharge portion for preventing the jam and the drop of the sheet. The full stacked state detecting portion is a means for detecting whether or not an amount of the sheets stacked at the sheet discharge portion reaches not less than a certain amount (full stacked state), and when the full stacked state of the sheets at the sheet discharge portion is detected, the image forming apparatus stops the image formation. With demands for downsizing and a cost reduction of the image forming apparatus in recent years, a proposal of an image forming apparatus in which the jam and drop of the sheet are prevented using an alternative means without providing the full stacked state detecting means has been made. For example, an image forming apparatus described in Japanese Laid-Open Patent Application (JP-A) 2011-180533 includes a sheet feeding detecting means for detecting the presence or absence of the sheet to be discharged toward the sheet discharge portion. The number of sheets discharged (discharged stop number) to the sheet discharge portion is integrated by the sheet feeding detecting means, and when the integrated discharged stop number exceeds a predetermined number of sheets, the image formation is stopped. Then, the image forming apparatus releases (eliminates) the stop of the image formation by clearing the integrated number of sheets (integrated sheet number) through a panel operation at an operating portion which is a user interface or by clearing the integrated sheet number after a lapse of a certain time.

However, in the above-described constitution in which the discharged sheet number to the sheet discharge portion is integrated, there was a case where the image formation was stopped although the sheets at the sheet discharge portion were not in the full stacked state in actuality. For example, in the case where the image formation of a small number of sheets is carried out, there is a possibility that a user immediately removes the sheet(s), on which the image is formed, from the sheet discharge portion. In such a situation, although the sheets on which the image is formed are less kept stacked at the sheet discharge portion, the discharged sheet number, which is actually small, is integrated and reaches a predetermined number of sheets, so that the image forming apparatus stops the image formation. As a result, the user performs an unnecessary operation for releasing the stop of the image formation or unnecessarily awaits subsequent image formation. Thus, there was a problem such that usability was lowered.

### SUMMARY OF THE INVENTION

The present invention has been accomplished in the above-described circumstances, and a principal object of the present invention is to provide an image forming apparatus capable of improving usability in a constitution in which a device for detecting a full stacked state of sheets at a sheet discharge portion is not provided.

According to an aspect of the present invention, there is provided an image forming apparatus comprising: an image forming portion for forming an image on sheets; a stacking portion for stacking the sheets on which the images are formed by the image forming portion; and a controller for integrating the number of sheets on which the images are formed, wherein the controller integrates the number of sheets, from an initial value in one print job, on which the images are formed by the image forming portion and which are then stacked on the stacking portion, and stops an operation of the image forming portion when an integrated value reaches a predetermined number.

These and other objects, features and advantages of the present invention will become more apparent upon a consideration of the following description of the preferred embodiments of the present invention taken in conjunction with the accompanying drawings.

### BRIEF DESCRIPTION OF THE DRAWINGS

FIG. 1 is a sectional view showing a structure of a color laser printer in Embodiments 1 and 2.

In FIG. 2, (a) to (c) are time charts of the presence or absence of a sheet, an output of a feeding sensor, and an integrated sheet number (sheet count), respectively in Embodiments 1 and 2.

FIG. 3 is a flowchart of a control sequence of an engine controller in Embodiment 1.

FIG. 4 is a flowchart of a control sequence of a video controller in Embodiment 2.

### DESCRIPTION OF THE EMBODIMENTS

Embodiments of the present invention will be described with reference to the drawings.

### Embodiment 1

### Outline of Image Forming Apparatus

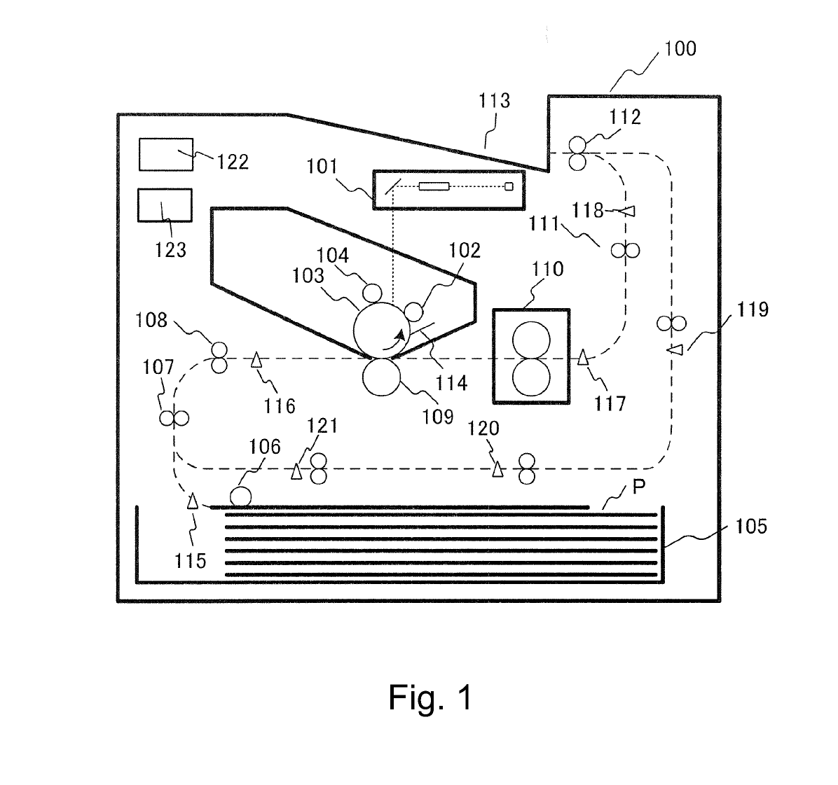

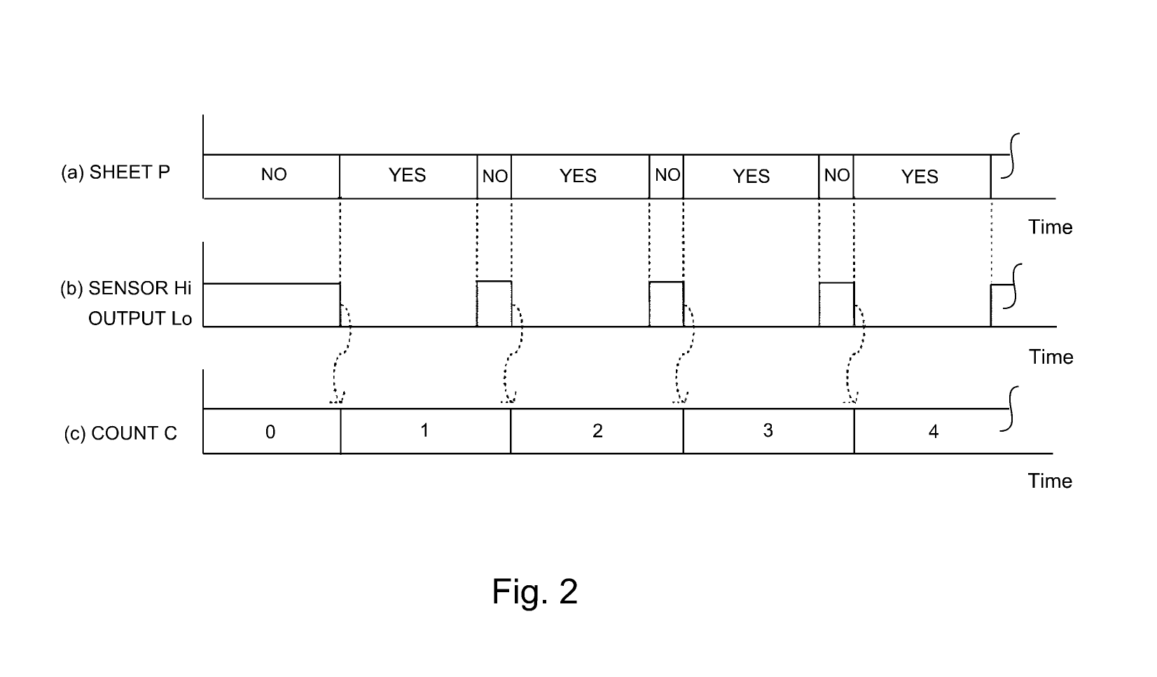

FIG. 1 is a schematic sectional view of an image forming apparatus 100 using electrophtographic recording technology in Embodiment 1.

In FIG. 1, when a print signal is generated, a scanner unit 101 emits laser light modulated depending on image information and scans a photosensitive drum 103 electrically charged to a predetermined polarity by a charging roller 102. As a result, an electrostatic latent image is formed on the photosensitive drum 103. To this electrostatic latent image, a toner is supplied from a developing device 104, so that a toner image is formed on the photosensitive drum 103. On the other hand, sheets P as a recording material accommodated in a sheet feeding cassette 105 are fed one by one by a pick-up roller 106, and then the sheet P is fed toward a registration roller pair 108 by a roller pair 107. Then, the sheet P is fed from the registration roller pair 108 in synchronism with timing when the toner image on the photosensitive drum 103 reaches a transfer nip formed by the photosensitive drum 103 and a transfer roller 109. In a process in which the sheet P passes through the transfer nip, the toner image is transferred from the photosensitive drum 103 onto the sheet P. Thereafter, the sheet P is heated by a fixing device 110, so that the toner image is heat-fixed on the sheet P. The sheet P no which the fixed toner image is carried is discharged onto a discharge tray 113 at an upper portion of the printer by roller pairs 111 and 112. A cleaner 114 removes the toner remaining on the photosensitive drum 103 without being transferred.

Further, feeding sensors 115 to 121 are provided on a feeding path for the sheet P and detect passing of the sheet P. The sheet P passes once through the feeding sensors 115 to 118 during one-side printing, and passes twice through the feeding sensors 116 to 118 during double-side printing. On the other hand, the feeding sensors 119 to 121 are provided in a feeding path, for the double-side printing, along which the sheet P does not pass during the one-side printing but passes one per one sheet during the double-side printing. Incidentally, the sheet P which is turned upside down and then is fed along the feeding path for the double-side printing is fed again to the transfer nip. The image forming apparatus further includes an unshown user operation detecting portion for detecting access of a user to the image forming apparatus, such as an operation of an unshown operating panel, opening and closing of the sheet feeding cassette 105, or opening and closing of a maintenance door for jam clearance or exchange of consumables.

Further, an engine controller 122 which is a second controller is constituted by a control circuit for effecting control of the image formation and in which an unshown single chip microcomputer incorporating therein CPU, ROM and RAM is mounted. Incidentally, the engine controller 122 is not always limited to the single microcomputer, but, e.g., each of the CPU, the ROM and the RAM is constituted as an independent element. Further, in the ROM, a program and data for controlling the engine controller 122 are stored, and the RAM is a memory used for permitting a control program executed by the engine controller 122 to temporarily store information in the memory.

Into the engine controller 122, in order to detect a feeding state of the sheet P, signals outputted from the feeding sensors 115 to 121 are inputted. The engine controller 122 collectively controls operations of the image forming apparatus including control of a driving source such as an unshown motor relating to image formation, control relating to image formation, control relating to failure detecting, and the like. Further, the engine controller 122 detects the operation, to the image forming apparatus by the user, by the unshown user predetermined detecting portion described above.

A video controller 123 which is a first controller interfaces with the user via an unshown host computer. Also in the video controller 123, similarly as in the engine controller 122, an unshown single chip microcomputer incorporating therein CPU, ROM and RAM is mounted. The video controller 123 is not always limited to the single chip microcomputer, but, e.g., each of the CPU, the ROM and the RAM may also be constituted by an independent element. Further, in the ROM, a program and data for controlling the video controller 123 are stored, and the RAM is a memory used for permitting a control program executed by the video controller 123 to temporarily store information in the memory.

The video controller 123 receives print data including image data, such as various data of PDL (page description language which is a language for describing an output image to provide an instruction to the image forming apparatus), via the unshown host computer. Then, on the basis of the received image data, the video controller 123 generates print information consisting of dot data, and controls emission of laser light from the laser in the scanner unit 101. The engine controller 122 and the video controller 123 communicate with each other by a known communication technology (e.g., serial communication). For example, communication as to control information including a print condition such as designation of a sheet feeding destination, a sheet discharging destination or the sheet, a print start instruction, a print end instruction, image writing timing and the like is made between the engine controller 122 and the video controller 123. Then, the engine controller 122 performs the image forming operation on the basis of the control information obtained from the video controller 123.

### [Maximum Stacked Sheet Number of Sheets of Sheet Feeding Cassette and Discharge Tray]

Next, the maximum stacked sheet number of sheets of the sheet feeding cassette 105 and the discharge tray 113 will be described. The maximum stacked sheet number of sheets of the sheet feeding cassette 105 is about 500 sheets in terms of a basis weight of 80 g/m². Further, the maximum stacked sheet number of sheets stackable on the discharge tray 113 is about 250 sheets in terms of the basis weight of 80 g/m². Therefore, the number of sheets limited (limited sheet number) which is the stacked sheet number of sheets which can be prevented from jamming and dropping with respect to the discharge tray 113 is 250 sheets. In this embodiment, the limited sheet number is 250 sheets, but may only be required to be set at the number of sheets in which the jam and the drop of the sheet with respect to the discharge tray 113 can be prevented, and thus is not limited to 250 sheets. Further, the number of sheets in which the jam and the drop of the sheet with respect to the discharge tray 113 are caused to occur varies depending on the thickness of the sheet, and therefore the limited sheet number may also be made variable depending on the species (e.g., the thickness) of the sheet used. Accordingly, e.g., in the case where the sheet is thick paper and the number of sheets in which the jam and the drop of the sheet with respect to the discharge tray 113 are caused to occur is 200 sheets, the limited sheet number may only be required to be changed from 250 sheets to 200 sheets.

Further, in the case where a plurality of discharge trays are provided, the limited sheet number may only be required to be switched depending on the discharge tray selected by the user. For example, in the case where the image forming apparatus is provided with an optional discharge tray on which the maximum stacked sheet number is about 150 sheets and the sheets are discharged on the optical discharge tray, the limited sheet number may only be required to be switched from 250 sheets to 150 sheets. In this embodiment, a table in which the species of the sheet and the limited sheet number of the discharge tray 113 are associated with each other is stored in, e.g., the ROM of the engine controller 122. Further, in the case where the image forming apparatus is provided with the plurality of the discharge trays, a table associated with each of the discharge trays is stored.

[Calculation of Discharged Sheet Number onto Discharge Tray]

Next, a method of integrating (adding up) the number of sheets P discharged onto the discharge tray 113 will be described with reference to FIG. 2. In FIG. 2, (a), (b) and (c) are time charts showing a relationship among the sheet P passing through the feeding sensor, an output of the feeding sensor and the integrated sheet number of sheets, respectively, in which the abscissa of each of the time charts represents time. In FIG. 2, (a) shows a state of the sheet P passing through the feeding sensor, in which “YES” shows that the sheet P during passing thereof through the feeding sensor exists, and “NO” shows that there is no sheet P during passing thereof through the feeding sensor. In FIG. 2, (b) shows the output signal of the feeding sensor, in which in the case where the output signal is at a “Hi” (high) level, the output signal shows that there is no sheet P during the passing, and in the case where the output signal is at a “Lo” (low) level, the output signal shows that the sheet P during the passing exists.

In FIG. 2, (c) is a schematic diagram showing a change in counter showing the integrated sheet number of sheets, a value of the counter is updated at the time of fall of the output signal of the feeding sensor in (b) of FIG. 2, i.e., at the time when a leading end of the sheet P reaches the feeding sensor. In this embodiment, using a detection result of the sheet P by the feeding sensor 118, the engine controller 122 integrated the number of sheets on the basis of the detection result of the feeding sensor 118, but the present invention is not limited thereto. A constitution in which the number of occurrences of the sheet feeding from the sheet feeding cassette 105 is integrated may also be employed. In this case, a command or an instruction for feeding the sheet is monitored, and then on the basis of a monitoring result, the integration is carried out may also be employed. In the following, the number of sheets discharged and integrated is represented by a variable C. In this embodiment, the integration is carried out using the detection result of the feeding sensor 118, but the feeding sensor may only be required to be disposed on the feeding path for the sheet P, and therefore is not limited to the feeding sensor 118 provided on the feeding path between the fixing device 110 and the discharge tray 113. Further, as a computing means for carrying out the integration, the engine controller 122 is used, but a hardware circuit such as an integrated circuit (ASIC) may also be used.

The engine controller 122 uses an internal register included, as a storing place where the integrated sheet number C is stored, in the engine controller 122. When the image formation is started, the engine controller 122 sets a value of the internal register for storing the integrated sheet number C at 0 (zero) as the initial value. Then, the engine controller 122 updates the integrated sheet number C by adding 1 to the value of the integrated sheet number C, every detection of the fall of the output signal of the feeding sensor 118, stored in the internal register. The detection of the fall of the output signal of the feeding sensor 118 is required so as not to be erroneously made as detection of rise of the output signal due to electrical noise or chattering by mechanical variation. For that reason, the engine controller 122 performs, e.g., a digital filtering process or a well-known chattering-removing process such that when detection that a signal level after the fall of the output signal is not changed but is stable is made, the signal level is determined. The output signal of the feeding sensor 118 is always monitored by the engine controller 122. Further, a reading period of the output signal of the feeding sensor 118 in the engine controller 122 is a period sufficiently short for discriminating whether or not the sheet during the feeding is in the feeding path.

Further, in this embodiment, the integrated sheet number in the case of the one-side printing is described, but in the case of the double-side printing, computation of the integrated sheet number C is made so that 2 pages constitutes one sheet. For that reason, e.g., in the case where the integrated sheet number C is computed using the feeding sensor predetermined on the feeding path for a first stop (side) and a second stop (side) of the sheet, a computing method in which 1 is added to the value of the integrated sheet number C stored in the internal register every twice of detection of the fall of the feeding sensor may be used. Further, a method of adding 1 to the value of the integrated sheet number C every detection of the feeding sensor provided on the feeding path for the double-side printing may also be used.

As described above, with respect to the discharge tray 113, the number of sheets P in which the jam and the drop are caused to occur varies depending on the thickness of the sheets to be discharged. For that reason, when the initial value of the integrated sheet number C is set at 0 (zero), depending on the thickness of the sheets to be used, there is a need to change the limited sheet number of sheets stackable on the discharge tray 113. Therefore, the maximum number of sheets stackable on the discharge tray 113 is used as the limited sheet number which is fixed value, and the initial value of the integrated sheet number C may be made variable depending on the species of the sheet to be fed. For example, in the case where the sheet is the thick paper and the number of sheets which cause the jam and the drop with respect to the discharge tray 113 is 200 sheets, the initial value may be switched from 0 to 50 (=250−200) while keeping the limited sheet number at 250 sheets.

Further, in the case where the plurality of the discharge trays are provided, the initial value may also be switched depending on the limited sheet number for the discharge tray selected by the user. For example, in the case where the image forming apparatus is provided with an optical discharge tray of which the maximum stacked sheet number is about 150 sheets, and the sheets are discharged onto this optional discharge tray, the initial value may be switched from 0 to 100 (=250−150). In this case, the limited sheet number is read from the above-described table in which the species of the sheet and the limited sheet number for the discharge tray are associated with each other, and then a value obtained by subtracting the read limited value from the fixed value may only be required to be used as the initial value. Further, a table in which the species of the sheet and the initial value corresponding to the species of the sheet are associated with each other is stored in, e.g., the ROM of the engine controller 122 and then the initial value depending on the species of the sheet is read from the table and set when the print job is executed. Further, in the case where the plurality of the discharge trays are provided, a table associated with each of the discharge trays may also be stored.

### [Control Sequence of Engine Controller]

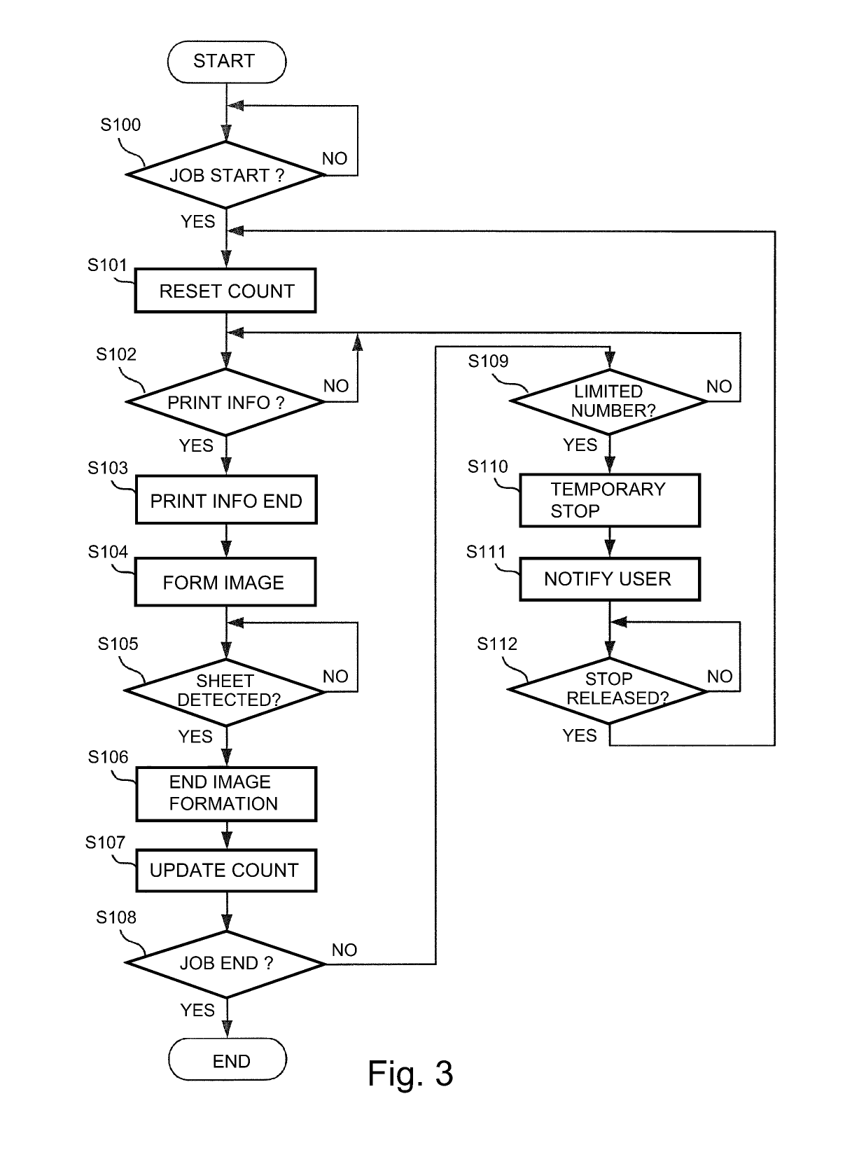

FIG. 3 is a flowchart showing a control sequence of the engine controller 122 during the image formation in this embodiment. The control sequence during the image formation will be described with reference to FIG. 3. When a power source of the image forming apparatus is turned on and the control sequence goes to an operation state, in step 100 (S100), the engine controller 122 discriminates whether or not start (signal) of the print job is received from the video controller 123. In the case where the engine controller 122 discriminates that the print job start (signal) is received, the control sequence goes to S101, and in the case where the engine controller 122 discriminates that the print job start is not received, the engine controller 122 repeats the process of S100. In S101, the engine controller 122 resets the internal register storing therein the integrated sheet number C (hereinafter, simply referred to as the integrated sheet number C) and sets the integrated sheet number C at 0 (zero) which is the initial value. Further, the engine controller 122 stores, in the RAM, control information including the print condition such as designation of the sheet feeding destination, the sheet discharging destination or the sheet, the print start instruction, the print end instruction, the image writing timing and the like which are received from the video controller 123.

In S102, the engine controller 122 discriminates whether or not the print information corresponding to one sheet to be subjected to the image formation is received from the video controller 123. The print information is sent from the video controller 123 to the scanner unit 101, and when the sending of the print information is completed, the engine controller 122 is notified of the completion of the print information sending from the video controller 123. In the case where the completion of the print information sending is received, the control sequence of the engine controller 122 goes to S103, and in the case where the completion of the print information sending is not received, the engine controller 122 repeats the process of S102. In S103, the engine controller 122 sends the print information sending completion to the video controller 123. In S104, the engine controller 122 starts feeding of the sheet on the basis of the print condition such as designation of the sheet feeding destination, the sheet discharging destination or the species of the sheet, which is received from the video controller 123. Then, the engine controller 122 drives the image forming portion, and carries out a series of image forming operations such as the transfer of the toner image onto the sheet and the fixing of the toner image on the sheet.

In S105, on the basis of the output signal of the feeding sensor 118, the engine controller 122 discriminates whether or not the feeding sensor 118 detects the sheet on which the image is formed. In the case where the output of the feeding sensor 118 is at the “Lo” (low) level, the engine controller 122 discriminates that the feeding sensor 118 detects the sheet, and the control sequence goes to S106. On the other hand, in the case where the output of the feeding sensor 118 is at the “Hi” (high) level, the engine controller 122 discriminates that the feeding sensor 118 does not detect the sheet, and repeats the process of S105. In S106, the image formation of the sheet for one page is ended, and therefore the engine controller 122 sends the end of the image formation to the video controller 123. In S107, the engine controller 122 adds 1 to the integrated sheet number C, thus updating the integrated sheet number C.

In S108, the engine controller 122 discriminates whether or not the end of the print job is received. In the case where the engine controller 122 discriminates that the print job end is received, the engine controller 122 ends the process, and in the case where the engine controller 122 discriminates that the print job end is not received, the control sequence goes to S109. The print job end refers to the sending, from the video controller 123 to the scanner unit 101, of the print information converted from the whole of the image information of one print job received from the unshown host computer. In S109, the engine controller 122 reads out the limited sheet number (e.g., 250 sheets), for the discharge tray 113, corresponding to the sheet used from the table stored in the ROM, and then discriminates whether or not the value of the integrated sheet number C reaches the limited sheet number. In the case where the engine controller 122 discriminates that the value of the integrated sheet number C does not reach the limited sheet number, the control sequence is returned to S102, and in the case where the engine controller 122 discriminates that the value of the integrated sheet number C reaches the limited sheet number, the control sequence goes to S110.

In S110, the engine controller 122 temporarily stops the image formation, i.e., stops the feeding of a new sheet, completes an operation for forming the image on the sheet(s) P remaining in the image forming apparatus, and ends the discharge of the sheet onto the discharge tray 113. In S111, the engine controller 122 notifies the user to remove the sheet on the discharge tray 113 at a displaying device of an unshown operating portion which is a user interface. When the user removes the sheet from the discharge tray 113, the user instructs release of the temporary stop by the panel operation of the unshown operating portion in order to release the temporary stop of the image formation. In S112, the engine controller 122 discriminates whether or not the notification that the panel operation which instructs the release of the temporary stop of the image formation is received from the above-described user operation detecting portion.

In the case where the engine controller 122 discriminates that the notification from the user operation detecting portion is received, the control sequence is returned to S101, and in the case where the engine controller 122 discriminates that the notification from the user operation detecting portion is not received, the engine controller 122 repeats the process of S112.

In this embodiment, the release of the temporary stop by the user is made by the operation through the unshown operating panel, but detection that the user directly operates the image forming apparatus may only be required to be made, and the release of the temporary stop is not limited thereto. For example, a button exclusively for an instruction to release the temporary stop or a button exclusively for a temporary stop instruction is provided on the image forming apparatus, and a button operation by the user may be detected. A button for anther function may also be used in place of the button described above.

In the description with reference to FIG. 3, the feeding sensor 118 was used for detecting the sheet. The feeding sensor 118 is provided downstream of the fixing device 110 with respect to a sheet feeding direction. For that reason, the engine controller 122 discriminates that the image formation of the sheet is completed by the detection of the sheet by the feeding sensor 118. The sheet detection is not limited to that by the feeding sensor 118, but may also be that by, e.g., the feeding sensor 117 provided immediately behind an exit of the fixing device 110 with respect to the sheet feeding direction. In the case where the feeding sensor 117 is used, at the time when the feeding sensor 117 detects the leading end portion of the sheet, there is a possibility that a trailing end portion of the sheet is not discharged from the fixing device 110. For that reason, in order to discriminate the completion of the image formation by using the feeding sensor 117, the feeding sensor 117 may only be required to be changed so that the rise of the output (signal) changed in level from the “Lo” (low) level to the “Hi” (high) level is detected.

In this embodiment, the method in which the value of the integrated sheet number C is set at 0 was described, but a method in which the above-described limited sheet number is fixed and the initial value is changed depending on the species of the sheet may also be used. Further, in this embodiment, as the storing place of the integrated sheet number C, the internal register of the engine controller 122 was used, but the integrated sheet number C may also be stored in the RAM.

As described above, according to this embodiment, in the constitution including no device for detecting the full stacked state of the sheets at the sheet discharge portion, it is possible to prevent a lowering in usability. That is, the integration is made after the integrated sheet number C is reset every print job, and therefore only in the case where the number of sheets for one job is larger than the maximum stacked sheet number for the sheet discharge portion, the control of the temporary stop of the image formation is carried out for preventing the jam and the drop of the sheet. As a result, it is possible to reduce unnecessary stop of the image formation, so that it is possible to reduce unnecessary operation for releasing the stop of the image formation by the user and an occurrence of unnecessary waiting time of the user.

### Embodiment 2

In Embodiment 1, the embodiment in which the integrated sheet number of the sheets discharged on the sheet discharge tray was computed using the output signal of the feeding sensor was described. In this embodiment, an embodiment in which the video controller computes the integrated sheet number of the sheets, discharged on the discharge tray, on the basis of the number of occurrences of the sending of the print data received from the host computer to the scanner unit will be described. In this embodiment, constituent elements of the image forming apparatus are similar to those shown in FIG. 1 in Embodiment 1, and therefore will be omitted from description in this embodiment. Further, also the description in this embodiment will be made using the same reference numerals or symbols shown in FIG. 1.

### [Outline of Image Forming Apparatus]

As described above, the video controller 123 receives the print data for the print job via the unshown host computer. The video controller 123 is capable of discriminating a break point of one sheet, for one page, to be subjected to the image formation, on the basis of the received print data. Then, the video controller 123 develops the print information, consisting of dot data, every one page of the sheet on the basis of the received print data. The developed print information is stored in, e.g., an image memory, such as NVRAM (non-volatile memory), provided in the video controller 123. In this embodiment, the video controller 123 is capable of storing the print information and control information which correspond to 30 pages at the maximum. Then, the video controller 123 sends the print information stored in the image memory to the scanner unit 101, and then controls emission of the light from the laser in the scanner unit 101. By the control of the engine controller 122, the print information for the page subjected to image formation of the sheet is deleted from the image memory, and then print information and control information or a subsequent page are newly developed and are stored in the image memory.

Further, the video controller 123 not only generates the print information to be sent to the scanner unit 101 but also sends, to the engine controller 122, the control information such as the print condition including the designation of the sheet feeding destination, the sheet discharging destination and the species of the sheet. The control information is information which should be shared by the engine controller 122 and the video controller 123. For that reason, the control information is stored in the NVRAM (non-volatile memory) which is a shared memory to which both of the engine controller 122 and the video controller 123 have access. The shared memory which is the storing portion may be the NVRAM (non-volatile memory) provided in either one of the engine controller 122 and the video controller 123 if both of the engine controller 122 and the video controller 123 have access to the shared memory. Further, if both of the engine controller 122 and the video controller 123 have access to the shared memory, the shared memory may also be provided as the NVRAM (non-volatile memory) for an independent storing device.

### [Control Sequence by Video Controller]

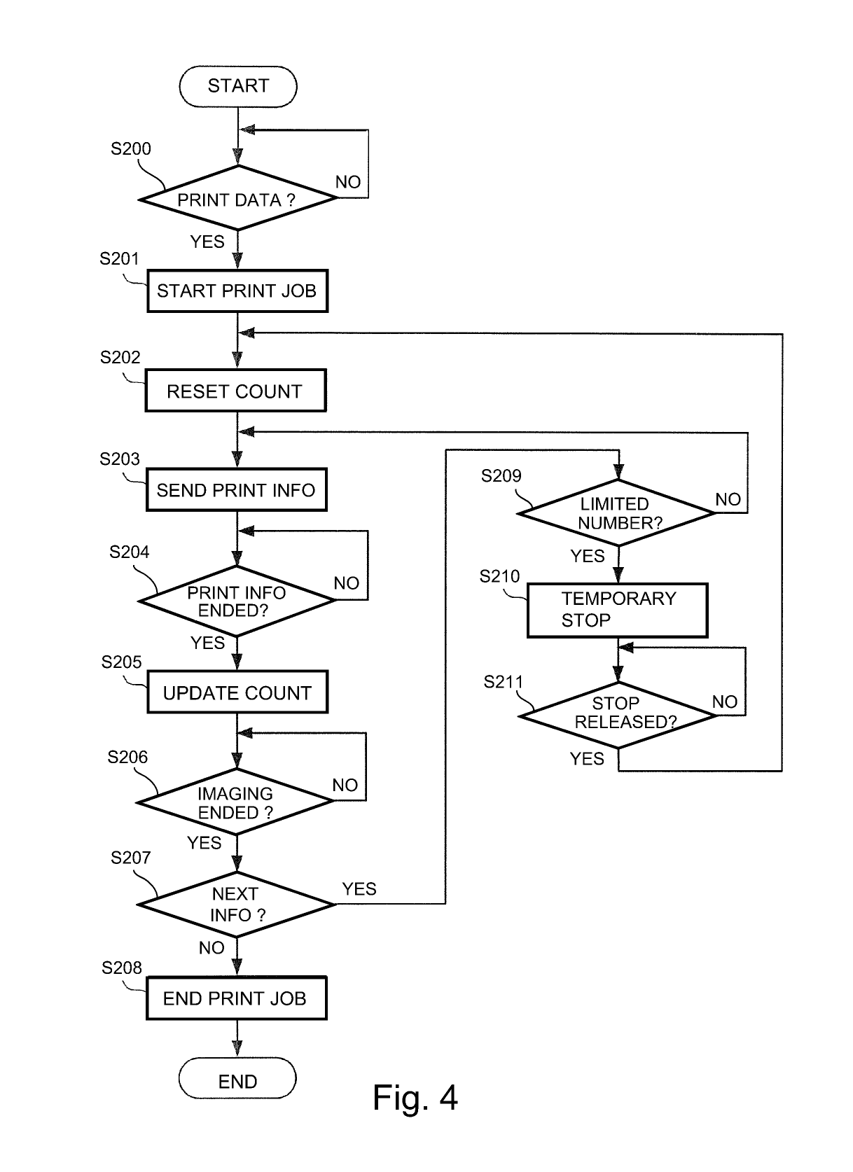

FIG. 4 is a flowchart showing a control sequence of the video controller 123 during the image formation in this embodiment. The control sequence during the image formation will be described with reference to FIG. 4. In this embodiment, the information of the integrated sheet number C is stored in the above-described shared memory. Further, in this embodiment, the table in which the species of the sheet and the limited sheet number for the discharge tray 113 are associated with each other is stored in the ROM of the shared memory to which both of the engine controller 122 and the video controller 123 have access. Further, in the case where the image forming apparatus is provided with the plurality of discharge trays, the table associated with each of the discharge trays is stored in the ROM of the shared memory. When a power source of the image forming apparatus is turned on and the control sequence goes to an operation state, in S200, the video controller 123 discriminates whether or not print data for the print job is received from the unshown host computer. In the case where the video controller 123 discriminates that the print data is received, the control sequence goes to S201, and in the case where the video controller 123 discriminates that the print data is not received, the video controller 123 repeats the process of S200.

In S201, the video controller 123 develops and stores the print information every one page on one sheet in the image memory with respect to the received print data, and then stores, in the shared memory, the control information such as designation of the sheet feeding destination, the sheet discharging destination and the sheet every one page on one sheet. Then, the video controller 123 sends, to the engine controller 122, not only the print job start (signal) but also the control information such as designation of the sheet feeding destination, the sheet discharging destination and the sheet. In S202, the video controller 123 resets the value of the integrated sheet number C stored in the shared memory and sets the value of the integrated sheet number C at 0 (zero) which is the initial value.

In S203, the video controller 123 sends, to the scanner unit 101, the print information corresponding to one page on one sheet on the basis of the print information developed in the image memory. Then, when the sending of the print information is completed, the engine controller 122 is notified of the completion of the print information sending from the video controller 123. When the engine controller 122 receives the print information sending completion from the video controller 123, the engine controller 122 not only starts the image forming operation but also sends the print information receipt completion to the video controller 123. In S204, on the basis of the presence or absence of receipt of the print information receipt completion from the engine controller 122, the video controller 123 discriminates whether or not the receipt of the print information from the engine controller 122 is completed. In the case where the video controller 123 receives the print information receipt completion from the engine controller 122, the video controller 123 discriminates that the engine controller 122 completes the receipt of the print information, and the control sequence goes to S205. On the other hand, in the case where the video controller 123 does not receive the print information receipt completion from the engine controller 122, the video controller 123 discriminates that the engine controller 122 does not complete the receipt of the print information, and the video controller 123 repeats the process of S204.

In S205, the video controller 123 adds 1 to the integrated sheet number C stored in the shared memory, thus updating the integrated sheet number C. In S206, the video controller 123 discriminates whether or not the image formation is ended, depending on the presence or absence of receipt of notification from the engine controller 123 that the image formation of one sheet for one page is ended. In the case where the video controller 123 receives the image formation end from the engine controller 122, the video controller 123 discriminates that the image formation is ended, and the control sequence goes not S207. In the case where the video controller 123 does not receive the image formation end, the video controller 123 discriminates that the image formation is not ended, and repeats the process of S206.

In S207, on the basis of the print information developed into the image memory, the video controller 123 discriminates the presence or absence of the print information of the sheet to be subsequently subjected to the image formation. In the case where the video controller 123 discriminates that there is no subsequent print information, the control sequence goes to S208, and in the case where the subsequent print information exists, the control sequence goes to S209. In S208, the video controller 123 sends print job end to the engine controller 122, and ends the process. In S209, the video controller 123 reads out the limited sheet number (e.g., 250 sheets), for the discharge tray 113, corresponding to the sheet used from the table stored in the ROM of the shared memory, and then discriminates whether or not the value of the integrated sheet number C reaches the limited sheet number. In the case where the video controller 123 discriminates that the value of the integrated sheet number C does not reach the limited sheet number, the control sequence is returned to S203, and in the case where the video controller 123 discriminates that the value of the integrated sheet number C reaches the limited sheet number, the control sequence goes to S210.

In S210, the video controller 123 sends image formation temporary stop instruction to the engine controller 122 in order to notify the value of temporary stop of the image formation to remove the sheets, on the discharge tray 113, on which the image is formed. When the engine controller 122 receives the image formation temporary stop instruction, the engine controller 122 stops the feeding of a new sheet, completes an operation for forming the image on the sheet(s) P remaining in the image forming apparatus, and ends the discharge of the sheet onto the discharge tray 113. Then, the engine controller 122 notifies the user to remove the sheet on the discharge tray 113 at a displaying device of an unshown operating portion which is a user interface. When the user removes the sheet from the discharge tray 113, the user instructs release of the temporary stop by the panel operation of the unshown operating portion in order to release the temporary stop of the image formation. When the engine controller 122 detects the panel operation for releasing the temporary stop, the engine controller 122 sends temporary stop release completion notification to the video controller 123. In S211, in the case where the video controller 123 discriminates that the notification of the temporary stop release completion is received from the engine controller 122, the control sequence is returned to S202, and in the case where the video controller 123 discriminates that the notification is not received, the video controller 123 repeats the process of S211.

In this embodiment, the video controller 123 updates the information of the integrated sheet number C in the shared memory, but the engine controller 122 may also update the information of the integrated sheet number C in the memory, e.g., after the scanner unit 101 receives the print information. Further, in this embodiment, when the integrated sheet number C reaches the limited sheet number, the video controller 123 instructs the engine controller 122 to temporarily stop the image formation. For example, the engine controller 122 periodically checks the value of the integrated sheet number C stored in the shared memory to discriminate whether or not the integrated sheet number C reaches the limited sheet number, and then the image formation may also be temporarily stopped. In this case, the engine controller 122 can make prediction about temporary stop timing in advance by checking the integrated sheet number C stored in the shared memory, so that it is possible to perform a proper sequence process such that a continuous operation, of the driving source for the image forming apparatus, performed more than necessary can be obviated.

In this embodiment, similarly as in Embodiment 1, the method in which the value of the integrated sheet number C is set at 0 was described, but a method in which the limited sheet number is fixed and the initial value is changed depending on the species of the sheet may also be used. Incidentally, the integrated sheet number C is not stored in the shared memory, but similarly as in Embodiment 1, the integrated sheet number C, may also be stored in the internal register or the RAM of the video controller 123.

As described above, according to this embodiment, in the constitution including no device for detecting the full stacked state of the sheets at the sheet discharge portion, it is possible to prevent a lowering in usability. Also in this embodiment, similarly as in Embodiment 1, only in the case where the number of sheets for one job is larger than the maximum stacked sheet number for the sheet discharge portion, the control of the temporary stop of the image formation is carried out for preventing the jam and the drop of the sheet. As a result, it is possible to reduce unnecessary stop of the image formation, so that it is possible to reduce unnecessary operation for releasing the stop of the image formation by the user and an occurrence of unnecessary waiting time of the user.

While the invention has been described with reference to the structures disclosed herein, it is not confined to the details set forth and this application is intended to cover such modifications or changes as may come within the purpose of the improvements or the scope of the following claims.

This application claims priority from Japanese Patent Application No. 249187/2013 filed Dec. 2, 2013, which is hereby incorporated by reference.

What is claimed is:

1. An image forming apparatus comprising:
an image forming portion for forming an image on sheets;
a stacking portion for stacking the sheets on which the images are formed by said image forming portion; and
a controller for integrating the number of sheets on which the images are formed,
wherein said controller integrates the number of sheets, from an initial value in one print job, on which the images are formed by said image forming portion and which are then stacked on said stacking portion, and stops an operation of said image forming portion when an integrated value reaches a predetermined number.

2. An image forming apparatus according to claim 1, wherein the initial value is 0, and said controller sets the integrated value at 0 in one print job.

3. An image forming apparatus according to claim 1, further comprising a storing portion in which a species of the sheets and the number of sheets stackable on said stacking portion are associated with each other,
wherein the predetermined number is the number of sheets, stackable on said stacking portion, which is read out from said storing portion and which is associated with the species of the sheets on which the images are formed.

4. An image forming apparatus according to claim 1, further comprising a storing portion in which a species of the sheets and the number of sheets stackable on said stacking portion are associated with each other,
wherein the predetermined number is a maximum number of sheets stackable on said stacking portion, and
wherein the initial value is a value obtained by subtracting, from the predetermined number, the number of sheets stackable on said stacking portion, and the number of sheets is read out from said storing portion and which is associated with the species of the sheets.

5. An image forming apparatus according to claim 1, further comprising a detecting portion for detecting presence or absence of the sheets,
wherein said detecting portion is provided in a feeding path along which the sheets are fed when one-side printing is made, and
wherein said controller integrates the number of sheets on the basis of a detection result of said detecting portion.

6. An image forming apparatus according to claim 1, wherein said controller includes a first controller for generating print information for permitting image formation by said image forming portion on the basis of image data of the print job and a second controller for controlling said image forming portion on the basis of the print information.

7. An image forming apparatus according to claim 6, further comprising a storing portion to which each of the first and second controllers has access,
wherein the integrated value is stored in said storing portion.

8. An image forming apparatus according to claim 6, wherein the first controller updates the integrated value when the second controller receives the print information.

9. An image forming apparatus according to claim 6, wherein the first controller instructs the second controller to stop an image forming operation of said image forming portion when the integrated value reaches the print number of sheets.

10. An image forming apparatus according to claim 9, wherein the second controller stops the image forming operation of said image forming portion in accordance with the instruction from the first controller to stop the image forming operation.

11. An image forming apparatus according to claim 1, wherein said stacking portion is a tray for stacking the sheets on which the images are formed and which is then discharged to an outside of said image forming apparatus.

12. An image forming apparatus according to claim 1, wherein when the integrated value reaches the predetermined number of sheets, said controller notifies and urges a user to remove the sheets stacked on said stacking portion.
